(19) United States
(12) Patent Application Publication
(10) Pub. No.: US 2022/0293087 A1
(43) Pub. Date: Sep. 15, 2022

(54) System and Methods for Leveraging Audio Data for Insights

(71) Applicant: Socialmail LLC dba Sharetivity, Palo Alto, CA (US)

(72) Inventors: Ankesh Kumar, Palo Alto, CA (US); Torlach Rush, Trim (IE); Vivek Tyagi, Mumbai (IN)

(73) Assignee: Socialmail LLC dba Sharetivity, Palo Alto, CA (US)

(21) Appl. No.: 17/472,982

(22) Filed: Sep. 13, 2021

Related U.S. Application Data
(60) Provisional application No. 63/160,283, filed on Mar. 12, 2021.
(60) Provisional application No. 63/177,653, filed on Apr. 21, 2021.

(51) Int. Cl. G10L 15/02; G10L 15/26; G06F 3/16

(52) U.S. Cl. CPC G10L 15/02; G10L 15/26; G06F 3/165

(57) ABSTRACT

Disclosed are systems and methods for leveraging audio data for insights. A method for leveraging audio data for insights may include receiving a primary source, by which an audio source may be accessed, identifying the audio source, extracting an audio source identity from audio source metadata associated with the audio source, extracting a snippet from the audio source, which expresses one or more sentiments, generating value-add data for the audio source, generating a score indicating one or more sentiments, and reporting the audio source identity, the snippet, and the value-add data. The audio source may be one of a company executive source, a company source, a company specialty source, and a company organization type source, or a combination thereof.

### CROSS-REFERENCE TO RELATED APPLICATIONS

This application claims the benefit of U.S. Provisional Patent Application No. 63/160,283, filed Mar. 12, 2021, and U.S. Provisional Patent Application No. 63/177,653, filed Apr. 21, 2021, all of which are hereby incorporated by reference in their entirety.

### BACKGROUND OF INVENTION

Gleaning valuable insights from audio data has typically been a time-consuming endeavor. Insights from audio data, such as topics of interest and sentiments, are valuable for various applications, including sales. A unique understanding of a prospect and a company the prospect works for to engage the prospect can be very useful for sales and marketing purposes. This typically involves a large amount of research into a prospect and their company, often involving manual search and review of visual, audio, and text data, in order to find information related to topics with which a salesperson can help and engage a prospect. Often, other topics including hobbies, interests, and passions, also can indicate a prospect's motivations, and help a salesperson better engage with a prospect by appealing to said motivations and showing an effort on the salesperson's part to better understand the prospect and their company. Such research typically is performed manually by a salesperson and is time consuming and inefficient, for example, requiring a salesperson/user to navigate to multiple URLs to search for podcasts or other audio content about the account/company they are targeting. Search engines may be helpful, but may not have access to search certain third party sites and typically are not equipped to analyze audio data. Even with improved methods for information aggregation that might increase efficiency in collecting data on a prospect and company, with the increasing ease of sharing audio and video content, and increasing amount of data being shared, such as on social media, podcasts, video publishing sites, and audio and video networks, it is extremely time consuming to sift through and analyze all of the data, particularly audio data.

Thus, it is desirable to have improved methods of leveraging online audio data for insights useful for sales and marketing.

### BRIEF SUMMARY

The present disclosure provides techniques for leveraging audio data for insights useful for sales and marketing. A method for leveraging audio data for insights may include: receiving a primary source configured to provide access to an audio source; identifying the audio source from which the audio data may be obtained, the audio source comprising one, or a combination, of a company executive source, a company source, a company specialty source, and a company organization type source; extracting an audio source identity from audio source metadata associated with the audio source; extracting a snippet from the audio source, the snippet being identified as expressing one or more sentiments; generating value-add data associated with the audio source identity; generating a score associated with the one or more sentiments; and reporting the audio source identity, the snippet, and the value-add data. In some examples, the primary source comprises a URL. In some examples, the audio source comprises a podcast. In some examples, the audio source comprises an audio network conversation. In some examples, the audio source comprises a video. In some examples, the score comprises a polarity score. In some examples, the score comprises a subjectivity score. In some examples, the score comprises a rank score. In some examples, the rank score is derived from one or more other scores.

In some examples, the method also includes marking the audio data with a unique transaction identification (ID). In some examples, the method also includes selecting the primary source from one or more primary sources. In some examples, the method also includes categorizing the audio source into one or more of a company executive source, a company source, a company specialty source, and a company organization type source. In some examples, the method also includes transcribing a plurality of segments of the audio source using a speech to text algorithm. In some examples, the method also includes matching the audio source with one or more accounts associated with a user using a user profile. In some examples, the method also includes matching the audio source with one or more accounts associated with a target. In some examples, extracting the audio source identity comprises recognition of topics and keywords based on analysis of the audio source metadata. In some examples, extracting the audio source identity comprises matching the audio source with a set of given topics based on a user's preference. In some examples, extracting the audio source identity comprises matching the audio source with a set of topics based a categorization of the audio source. In some examples, extracting the audio source identity comprises generating a list of audio source guest names matched to company information. In some examples, extracting the audio source identity comprises extracting a topic and/or a keyword based on the audio source metadata. In some examples, extracting the audio source identity further comprises deriving a theme from the topic and/or the keyword.

### BRIEF DESCRIPTION OF THE DRAWINGS

FIG. 1 is an exemplary matrix of topics and sentiments, in accordance with one or more embodiments;

FIG. 2 is a simplified block diagram of an exemplary audio data leveraging system for insights, in accordance with one or more embodiments; and

FIG. 3 is a flow diagram illustrating an exemplary flow of data as it is processed by an audio data leveraging system for insights, in accordance with one or more embodiments;

FIG. 4 is a flow diagram illustrating an exemplary method for leveraging audio data for insights, in accordance with one or more embodiments;

FIG. 5 is a flow diagram illustrating an alternative exemplary method for leveraging audio data for insights, in accordance with one or more embodiments;

FIG. 6A is a simplified block diagram of an exemplary computing system configured to implement an audio data leveraging system for insights, in accordance with one or more embodiments; and

FIG. 6B is a simplified block diagram of an exemplary distributed computing system, in accordance with one or more embodiments.

FIGS. 7A-7B are diagrams showing exemplary segmentations of an audio file, in accordance with one or more embodiments.

FIGS. 8A-B are annotated audio file representations showing highlighted portions, in accordance with one or more embodiments.

FIG. 9 is a flow diagram illustrating an exemplary method for identifying and extracting a snippet from an audio file using an audio data leveraging system for insights, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for leveraging audio data for insights.

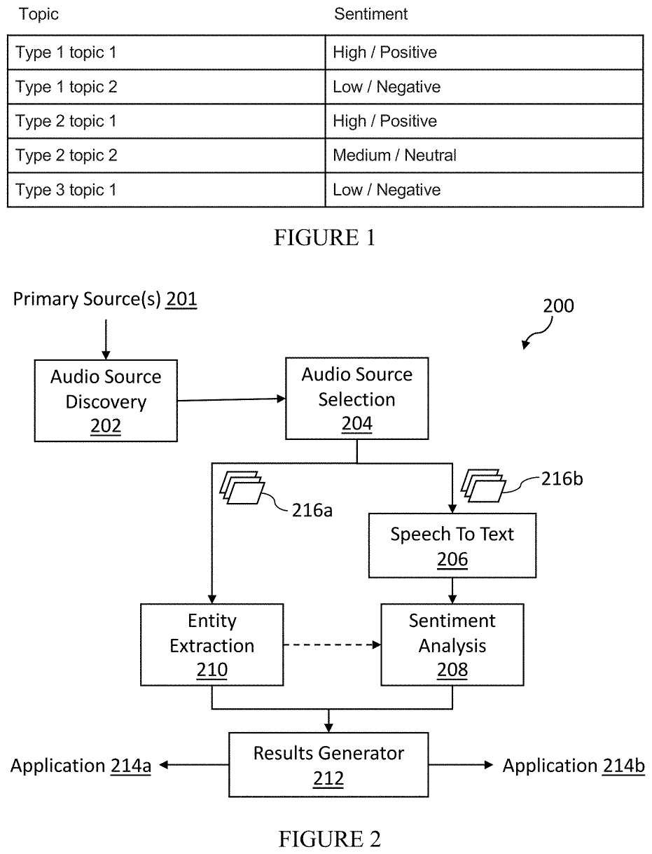

A sales prospect targeting model (e.g., using machine learning) may be used to analyze audio data for topic selection, prioritization of topics, and sentiment (i.e., understanding the feeling and emotions expressed therein and how they relate to a selected topic) relating to a sales prospect, the sales prospect's company, and other sales and marketing targets. Examples of audio data may include podcasts, videos (e.g., on Youtube®, Vimeo®, or other video publishing platform), interviews, audio networks, video networks, among other sources of audio. Sentiments gleaned from the audio data may highlight and emphasize one or more of the selected topics. For example, FIG. 1 is an exemplary matrix of topics and sentiments for a sample or source of audio data, including several types of topics, one or more topics of each type, and sentiments mapped to each of the one or more topics. Types of topics may be related to, without limitation, business relevance, icebreakers, professional expertise and interests, social and other soft topics, and the like. In some examples, a sales prospect targeting model may follow a hierarchy of topic types for topic selection, for example, starting with a pain point (i.e., business problem to be solved, including strategic and tactical imperatives and priorities), to other business relevance (i.e., topics and sentiments that a prospect and/or company cares about more), and then to various soft topics (e.g., social interests, affiliations, weather, an alma mater or other school affiliation, a hobby, other interests, icebreakers and topics to show empathy and understanding).

In some examples, sentiments may include a range from high to low and in between (e.g., high, medium, low, medium-high, medium-low, highest, lowest), as shown in FIG. 1. In other examples, sentiments may include additional gradations providing more color (i.e., non-binary qualities) or granularity to a sentiment associated with a topic (e.g., important to not important, good to bad, positive to negative, emotional reactions, tactical high to low, strategic high to low, political positive to negative, etc.).

In addition to uncovering topics and sentiments related to this hierarchy of topic types, the model may also categorize topics and sentiments into a prioritized set of categories for different purposes (e.g., sales engagement, market evaluation, target acquisition or recruitment). In an example, a salesperson may seek topics and sentiments that fall into the categories of business relevance and soft topics. In other examples, more categories or greater granularity (i.e., with subtopics) may be included in the model's prioritization algorithm. In some examples, topics and sentiments may be presented in a matrix, such as is shown in FIG. 1, showing how sentiments may highlight a topic (e.g., Type 1 topic 1 and Type 2 topic 1) or not highlight, and maybe deprecate, a topic (e.g., Type 1 topic 2 and Type 3 topic 1). A salesperson or other user may tailor said prioritized categories to a product, service or solution that is being sold, and said prioritized categories may inform the sales prospect targeting model's analysis.

A report may be generated to encompass a summary, a characterization, or a snippet, of one or more audio files, or a combination thereof, thereby highlighting the most important and relevant topics to, and surfacing insights about, a prospect based on the model's analysis of audio data by, about, or otherwise indicated to represent or provide insight into, a prospect and/or the prospect's company. For example, a summary (i.e., abstract) of a long-form audio content (e.g., podcast, audio recording of a lecture, audio recording of an interview, audio network discussion) or video content (e.g., published recording of a conference presentation, lecture, interview) may be generated, the summary providing an essence (e.g., highlighting impactful topics and sentiments) of the content. The report may be generated in a human readable or other format for fast and easy consumption by a salesperson, or in a format for consumption by a networking, sales, or marketing platform or service. In some examples, the report may organize the highlighted content according to the prioritized categories. In some examples, the report may score highlighted content according to values or priorities indicated by a user (e.g., a salesperson or other user).

In some examples, the report may be formatted for integration into a service (e.g., business networking site, customer relations management (CRM) platforms, sales engagement platforms, and other sites and platforms) used by a salesperson to conduct sales activities for easy access. Examples of such services include, without limitation, Linkedin®, Zoominfo®, Salesforce®, Salesloft®, Outreach®, and the like. In other examples, the report may be provided as a freestanding document in a format for ease of sharing, an automated e-mail, an encrypted e-mail or document, or other format. The report may comprise content (e.g., linked, attached, transcribed) curated by the model to represent topics from long form audio data shared by and/or about a sales prospect and their company that may be valuable to engaging said sales prospect and company. Thus, the report enables easy navigation to content with a high likelihood of being impactful to a salesperson's efforts at engaging a sales prospect. The report may be refreshed periodically or ad hoc to process newly available audio content using the model, with updated reports (i.e., comprising impactful content) being provided to a user (i.e., a salesperson) at a desired frequency (i.e., as may be specified by a user or predetermined by the reporting system).

In some examples, a machine learning (ML) pipeline may be configured to ingest content from audio transcripts of online audio and/or video data samples and to perform text classification, followed by multi-labelled aspect-based sentiment analysis, on said audio and/or video data samples. In some examples, such an ML model may be configured to topics highly relevant to priority categories, associated sentiments, as well as snippets of audio data or links to content representing said highly relevant topics. In other examples, predictions in the form of opinions and intentions (i.e., derived from above-referenced topics and sentiments) mined from the ML model may be rendered to a “smart page” that enables users to seamlessly compose icebreaker messages (e.g., emails, video, LinkedIn® messages, voicemails, phone calls, etc.).

Example System

FIG. 2 is a simplified block diagram of an exemplary audio data leveraging system for insights, in accordance with one or more embodiments. System 200 includes the following modules: audio source discovery 202, audio source selection 204, speech to text 206, sentiment analysis 208, entity extraction 210, and results generator 212. In some examples, audio source discovery 202 may receive as input a primary source(s) 201, which may include a URL (e.g., a company website, an individual or company LinkedIn® profile, a link to a podcast, and the like). Audio source discovery 202 may be configured to identify from which primary source(s) 201 to harvest data. In so doing, audio source discovery 202 may determine whether a primary source 201 is appropriate for establishing company relations information, including but not limited to identification of C-level and other executive or high level employees (e.g., CEO, CFO, COO, CMO, CLO, general counsel, general manager, vice president, corporate secretary, director, department head/lead), company type (e.g., family-owned, country or region-based, global or other corporation, conglomerate with subsidiary companies, subsidiary, limited liability company, partnership, limited partnership, sole proprietorship), company specialty (i.e., a product, a service, a target market or audience, a technology, a sector). In some examples, audio source discovery 202 may be configured to categorize an audio source from primary source 201. Examples of categories may include company executive audio sources, a company audio source, a company specialty audio source, a company organization type audio source, among other categories. A company executive audio source may comprise audio data wherein a company executive is identified as a guest, a speaker, an interviewee, a panelist, or otherwise identified as attributable to a significant amount of audio content from said audio source accessible from the primary source 201. A company audio source may comprise audio data related to the company itself (e.g., company marketing videos, product or service review videos, discussions of a company on an audio network), which may yield information about company achievements, challenges facing a company, company initiatives and priorities, and the like. A company specialty audio source categorization may be based on a company specialty, such as audio data providing information that may be industry-related, product-related, service-related, competition-related, among others. A company organization type audio source categorization may be based on a company type. It would be understood by one of ordinary skill in the art that other categories may be applied to an audio source.

Outputs from audio source discovery 202, including one or more audio sources and each audio source's associated categories, may be provided to audio source selection 204. Audio source selection 204 may be configured to select one or more audio sources based on desired categories. For example, audio source selection 204 may select an audio source based on a user indicated preference for a category of audio sources. Said preference may be indicated in real-time, or previously indicated and stored in a user profile or otherwise in association with a user. In some examples, audio source selection 204 may select an audio source using audio source metadata (e.g., title, description, file name, file extension, time stamp and other indications of audio source freshness). Audio source selection 204 may be configured to record (i.e., mark) selected audio data with a unique transaction identification (ID) and output said unique transaction ID to one or more downstream system components, such as speech to text 206, sentiment analysis 208, and entity extraction 210.

Audio source selection 204 also may output audio source metadata 216a, which includes audio source metadata that is recorded as part of the selection transaction. Audio source metadata 216a may be input to entity extraction 210, which may comprise a natural language processing (NLP) data model configured to recognize named entities (e.g., persons, titles, organization), as well as topics and keywords. In some examples, entity extraction 210 may be configured (i.e., trained) to recognize topics and keywords based on analysis of the metadata itself. In other examples, entity extraction 210 may be pre-programmed to identify a given set of topics and/or keywords based on a user's preferences (e.g., as may be indicated in a user profile) and/or a category of audio source. Entity extraction 210 may then output a list of audio source guest names matched to company information (e.g., a company name, a title) and useful audio content metadata (e.g., topics discussed, keywords). Entity extraction 210 also may be configured to derive themes from topics and keywords. Such themes may be used by results generator 212 to identify commonalities across multiple audio sources within a set of results, and may be identified by results generator 212 as broader insights for use by users (e.g., for targeted selling and marketing).

Audio source selection 204 also may output audio source content segments 216b (i.e., in native or other format), which may include clips of audio files comprising chunks (i.e., segments) of contiguous audio content (e.g., 10 seconds, 20 seconds, 30 seconds, 1 minute, or more or less or in between, depending on downstream use). In some examples, segments 216b may be divided based on natural pauses in speech such that related content is not cut off from each other (e.g., cuts are not mid-word, mid-sentence, mid-thought, mid-answer, etc.). Each audio source content segment 216b may be passed through speech to text 206 to be processed into transcript form for analysis by sentiment analysis 208. In some examples, speech to text 206 may comprise a customized or selected speech to text module or method based on metadata related to audio source content segments 216b (e.g., particular to industry (i.e., jargon) or technology (i.e., terms of art) and different languages). In other examples, audio source selection 204 may select a customized or particular speech to text algorithm from a plurality of available algorithms provided in speech to text 206 (e.g., IBM®'s Watson Speech to Text, Google® Speech-to-Text, Project DeepSpeech, CMUSphinx, Mozilla® Common Voice, and other speech to text algorithms), based on said metadata.

Sentiment analysis 208 may receive audio source content segments 216b, or alternatively, a sequence of transcripts for audio source content segments 216b from speech to text 206. Sentiment analysis 208 may comprise an NLP data model configured to recognize sentiments configured to output a snippet from audio source content segments 216b (e.g., in an audio clip format, transcript format, or other format), along with one or more scores associated with the snippet. The snippet may be selected or extracted as expressing one or more sentiments (e.g., as shown in FIG. 1). The one or more scores may include a polarity score, a subjectivity score, a rank score, and other scores. For example, a polarity score may indicate a measure of sentiment between positive (e.g., +1.0, +10, or other positive value as a highest positive) and negative (e.g., −1.0, 0, −10, or other negative value as a lowest negative), where there is a neutral value in between (e.g. 0 may be neutral in a range from −1.0 to +1.0 or −5.0 to +5.0, whereas 5 may be neutral in a range from 0-10, and the like). In another example, a subjectivity score may indicate a measure of objectivity and subjectivity for a sentiment (e.g., a range between 0 to 1 where 0 is highly objective and 1 is highly subjective, or other range of values with highly objective being represented on one end of the spectrum and highly subjective being represented on an opposite end of the spectrum).

In some examples, one score may be derived from a sum of, weighting, averaging, or otherwise computed using other scores. For example, the rank score may be derived from the polarity score and the subjectivity score, and may be used for presentation (i.e., to rank a plurality of snippets). In an example, a high or positive polarity may be combined with a desired subjectivity score may contribute to a better ranking (e.g., a very positive polarity score combined with a highly subjective subjectivity score may indicate a topic that is personally important to a target resulting in a higher ranking; on the other hand, a neutral polarity score with a highly objective subjectivity score may indicate a topic that is uninteresting to the target resulting in a lower ranking). In another example, extremes (i.e., either high or low, positive or negative, subjective or objective) may contribute to a higher rank, as topics relating to a target's challenges also may be of great value to a user. In still another example, a negative polarity score or subjectivity score may be given other treatment and highlighted differently to indicate problems and challenges to a target, particularly in areas wherein a user may be in a position to offer solutions.

In some examples, keywords or other terms from a snippet may be recorded and associated with said scores (i.e., to capture polarity and subjectivity scores at word level) to enable detailed searching within and among snippets. For example, polarity and subjectivity scores associated with a term may be used for placement and sizing (i.e., significance) of the term in a word cloud. Interactive word clouds may be generated, for example by results generator 212, which may provide for selection of terms from said word cloud to filter snippets associated with a selected term.

In some examples, sentiment analysis 208 may further identify or compile a subset of snippets (i.e., highlights) to contribute to a summary of the audio source, the summary configured to provide the overarching essence of the original audio source file, but shorter in length. The summary may be stored and referenced for ease of future research.

Results generator 212 may be configured to generate and store (e.g., in a repository) results data in a report document or other formats based on outputs (i.e., value-add data) from sentiment analysis 208 and entity extraction 210. Such a report (i.e., output) from results generator 212 may include a summary, a characterization, or a snippet, of one or more audio files, or a combination thereof. In some examples, applications 214a-b may comprise a service (e.g., business networking site, customer relations management (CRM) platforms, sales engagement platforms, and other sites and platforms) by which users may access results data (i.e., from results generator 212's repository). In other examples, a report or output from results generator 212 may include a plurality of sets (e.g., pages) of snippets with topic associations linked together in a structure for ease of discovery by a search engine, and applications 214a-b may include a search engine (e.g., running a search engine optimization (SEO) algorithm, application or tool) configured to provide snippets of audio search results. As mentioned herein, results data may be provided in the form of a report, a word cloud, or other format compatible with said services. In some examples, pre- and post-processing may be performed on the audio data, such as data cleansing.

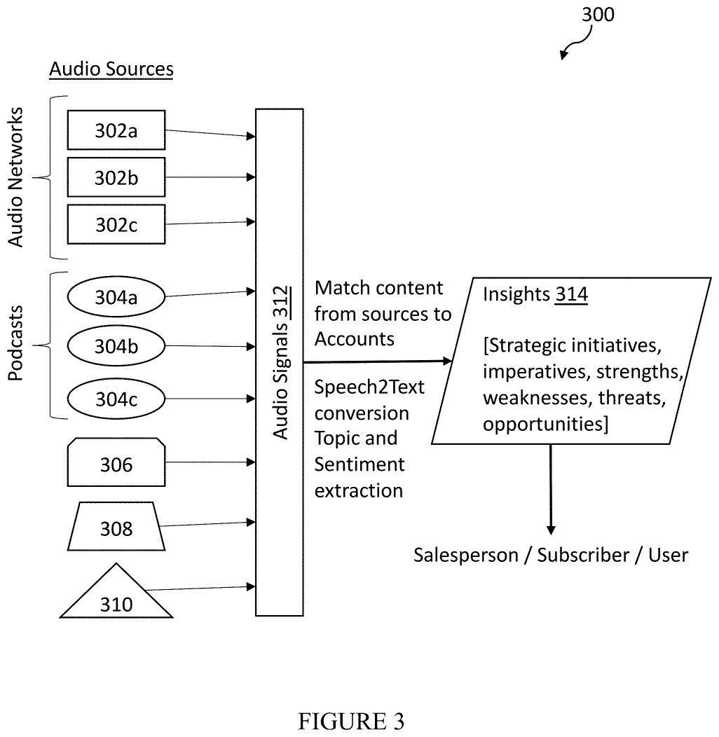

FIG. 3 is a flow diagram illustrating an exemplary flow of data as it is processed by an audio data leveraging system for insights, in accordance with one or more embodiments. In some examples, a source of audio data may include audio conversations from audio networks. For example, audio conversations taking place over an audio network, either in real time or a recording of a prior conversation, have become a common method for connecting with existing connections and developing new connections on that platform to discuss topics of interest. Audio data (i.e., audio files) from such conversations may be filtered by participants in order to extract each participant's individual comments. Such comments may be processed using an audio data leveraging system to benefit people that were not able to attend the conversation or were not invited. Companies providing these “audio networking” services include but are not limited to, Clubhouse, Quilt, Linkedin®, Twitter® and Facebook®. The methods described herein can be used to analyze the audio content, extract signals (e.g., metadata, entity information, sentiments, as described herein), synthesize those signals, prioritize them and provide them to users for the purpose of interacting with prospects or targets. Signals can be sourced from a single conversation, multiple conversations from one platform or from multiple platforms, and analyzed in combination with other signals from podcasts, earnings calls, videos, and other audio content.

As shown in FIG. 3, audio data from audio sources, including audio networks 302a-c, podcasts 304a-c, and other sources 306-310 (e.g., earnings calls, streaming or otherwise shared videos, and the like), may be aggregated and provided to audio signals 312, which may comprise an audio data leveraging system (e.g., system 200). Strength of audio signals for purposes of this method increase if the subject (i.e., prospect, company) is mentioned in multiple conversations, platforms, and even further increased if further mentioned in additional sources, such as earnings calls, podcasts, videos, and other audio-based services. Audio signals 312 may be analyzed using various methods described herein, such as matching content from sources to accounts (e.g., salesperson, subscriber, other users), speech to text conversion, and topic and sentiment extraction, in order to generate insights 314. Insights 314 may include strategic initiatives, imperatives, strengths, weaknesses, threats, opportunities, and more, for a prospect or prospect's company. Insights 314 may be provided to a salesperson, subscriber, or other user in a variety of formats, as described herein.

Example Methods

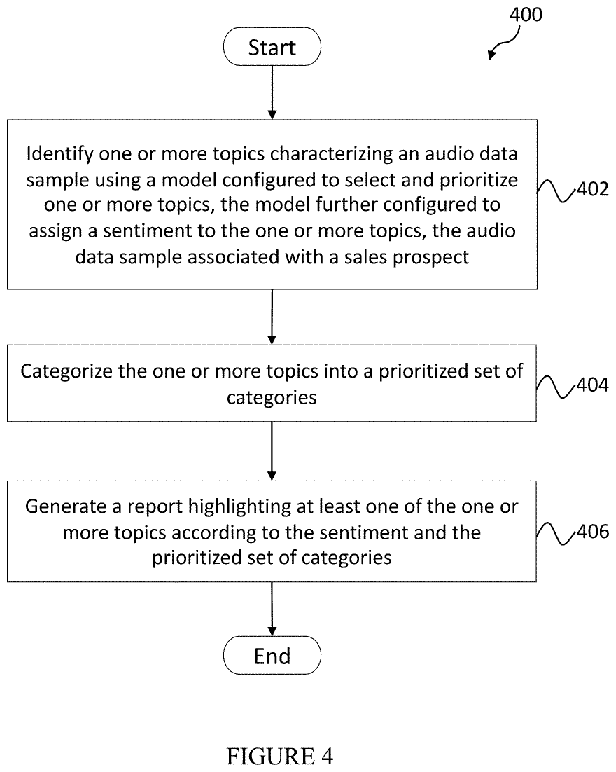

FIG. 4 is a flow diagram illustrating an exemplary method for leveraging audio data for sales engagement, in accordance with one or more embodiments. Method 400 may begin with identifying one or more topics characterizing an audio data sample using a model configured to select and prioritize one or more topics at step 402, the model further configured to assign a sentiment to the one or more topics, the audio data sample associated with a sales prospect. The model may be an ML model configured to ingest audio data and output one or more of topics, sentiments, audio data snippets, links to highly relevant content, predictions, as described herein. The one or more topics may be categorized into a prioritized set of categories at step 404. A report may be generated highlighting at least one of the one or more topics according to the sentiment and the prioritized set of categories at step 406. The report may include snippets of, transcriptions of, links to, or other means of navigating to, highly relevant content, in accordance with the prioritized categories. The report also may include a summary or abstract of the audio data sample.

In an example, a podcast hosted at a primary source (e.g., Apple Podcast®, Spotify®, Google Play™, and other podcast hosting site) may be discovered by an audio source discovery module (e.g., audio source discovery 202). Using a Linkedin® company profile, company information (e.g., URL, a name of the company, a company website, identifying information for executive level employees in the company) may be fetched. Using said company information, a search may be made of podcast providers (e.g., Google® podcast, Libsyn, Apple Podcast®) to match podcasts to said company information. In some examples, a business filter may be implemented, which may include a strict match and/or other checks of content to ensure accuracy of results (i.e., where company name is common and a normal preliminary search results in false positives).

In other examples, the name of a prospect, the prospect's company, and the prospect's title may be fetched from a Linkedin® user profile. The prospect's podcasts may be discovered through a stricter search (e.g., Boolean) on the prospect's name plus a platform name (e.g., “Jon Snow”+“Outreach”) to obtain results only for the prospect's name from a given platform (e.g., Jon Snow results from Outreach).

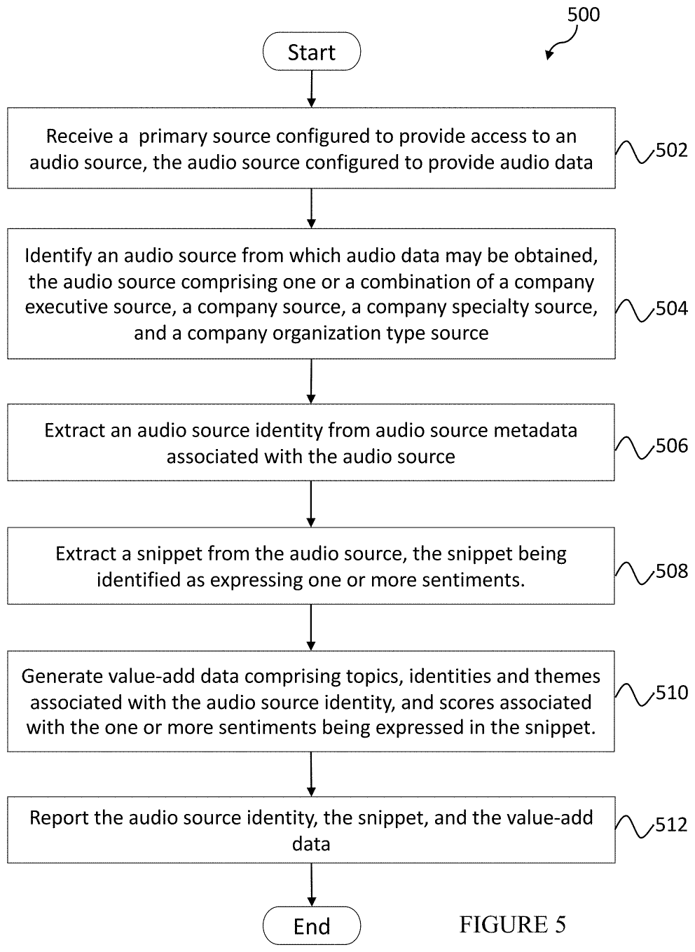

FIG. 5 is a flow diagram illustrating an alternative exemplary method for leveraging audio data for insights, in accordance with one or more embodiments. Method 500 may begin with receiving a primary source configured to provide access to an audio source at step 502, the audio source configured to provide access to audio data. An audio source from which audio data may be obtained may be identified in step 504, the audio source comprising one or a combination of a company executive source, a company source, a company specialty source, and a company organization type source. In some examples, the audio source may be marked (i.e., associated with) with a unique transaction identification (ID). An audio source identity may be extracted form audio source metadata associated with the audio source at step 506. The audio source identity may include names of persons, names of organizations, titles, and other such entity information that may be extracted by an entity extraction module (e.g., entity extraction 210). A snippet from the audio source may be extracted at step 508, the snippet being identified as expressing one or more sentiments. Value-add data may be generated at step 510. In some examples, the value-add data may include one or a combination of topics, identities, and themes associated with the audio source identity. In some examples, the value-add data may include a score (e.g., a polarity score, a subjectivity score, a rank score) associated with the one or more sentiments being expressed in the snippet. In some examples, the one or more sentiments may be cross-referenced with other value-add data (e.g., topics, identities, themes). In some examples, method 500 may further include identifying one or more primary sources from which to obtain the audio source and selecting a primary source from the one or more primary sources. In some examples, method 500 also may include categorizing the audio source (e.g., company executive, company, company specialty, company organization type, etc.). In some examples, method 500 further may include transcribing segments of the audio source content using a speech to text algorithm. In some examples, method 500 also may include matching the audio source content with accounts associated with a user (e.g., user profile specifying a user's preferences and target identities or characteristics) and/or a target.

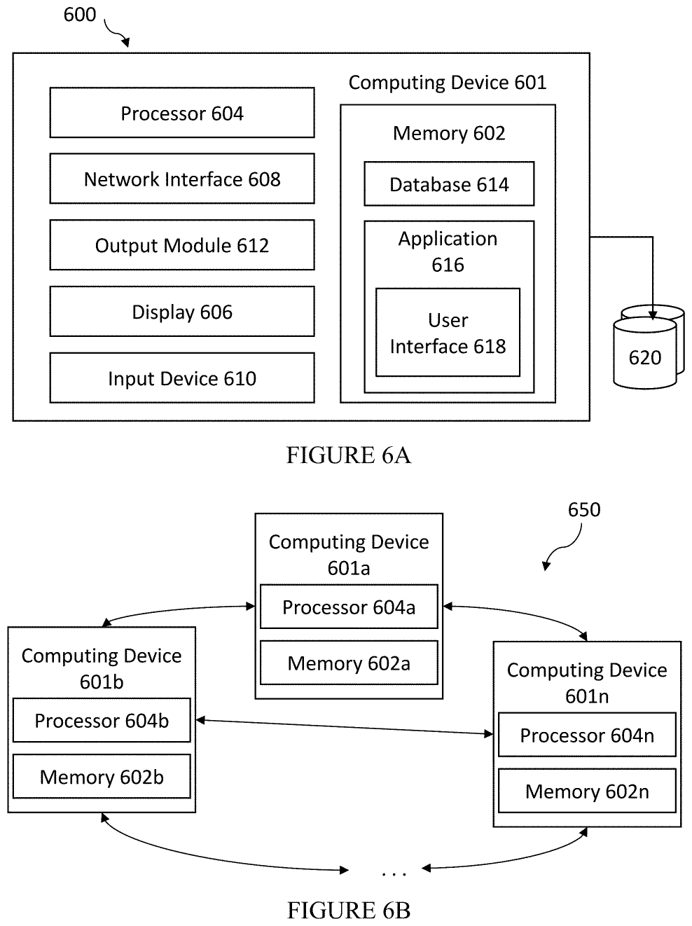

FIG. 6A is a simplified block diagram of an exemplary computing system configured to implement an audio data leveraging system for insights, in accordance with one or more embodiments. In one embodiment, computing system 600 may include computing device 601 and storage system 620. Storage system 620 may comprise one or more repositories and/or other forms of data storage, and it also may be in communication with computing device 601. In another embodiment, storage system 620, which may comprise a plurality of repositories, and may be housed in one or more of computing device 601. In some examples, storage system 620 may store audio data, audio files, user profiles, metadata, target information, instructions, programs, and other various types of information as described herein. This information may be retrieved or otherwise accessed by one or more computing devices, such as computing device 601, in order to perform some or all of the features described herein. Storage system 620 may comprise any type of computer storage, such as a hard-drive, memory card, ROM, RAM, DVD, CD-ROM, write-capable, and read-only memories. In addition, storage system 620 may include a distributed storage system where data is stored on a plurality of different storage devices, which may be physically located at the same or different geographic locations (e.g., in a distributed computing system such as system 650 in FIG. 6B). Storage system 620 may be networked to computing device 601 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 601 also may include a memory 602. Memory 602 may comprise a storage system configured to store a database 614 and an application 616. Application 616 may include instructions which, when executed by a processor 604, cause computing device 601 to perform various steps and/or functions, as described herein. Application 616 further includes instructions for generating a user interface 618 (e.g., graphical user interface (GUI)). Database 614 may store various algorithms and/or data, including neural networks (e.g., NLP for entity extraction or sentiment analysis, speech to text, other processing of audio data) and data regarding company information, target information, topics, sentiments, scores, among other types of data. Memory 602 may include any non-transitory computer-readable storage medium for storing data and/or software that is executable by processor 604, and/or any other medium which may be used to store information that may be accessed by processor 604 to control the operation of computing device 601.

Computing device 601 may further include a display 606, a network interface 608, an input device 610, and/or an output module 612. Display 606 may be any display device by means of which computing device 601 may output and/or display data. Network interface 608 may be configured to connect to a network using any of the wired and wireless short range communication protocols described above, as well as a cellular data network, a satellite network, free space optical network and/or the Internet. Input device 610 may be a mouse, keyboard, touch screen, voice interface, and/or any or other hand-held controller or device or interface by means of which a user may interact with computing device 601. Output module 612 may be a bus, port, and/or other interface by means of which computing device 601 may connect to and/or output data to other devices and/or peripherals.

In one embodiment, computing device 601 is a data center or other control facility (e.g., configured to run a distributed computing system as described herein), and may communicate with a service. As described herein, system 600, and particularly computing device 601, may be used for leveraging audio data for insights (i.e., extracting and presenting insights from audio data), as described herein. Various configurations of system 600 are envisioned, and various steps and/or functions of the processes described below may be shared among the various devices of system 600 or may be assigned to specific devices.

FIG. 6B is a simplified block diagram of an exemplary distributed computing system, in accordance with one or more embodiments. System 650 may comprise two or more computing devices 601a-n. In some examples, each of 601a-n may comprise one or more of processors 604a-n, respectively, and one or more of memory 602a-n, respectively. Processors 604a-n may function similarly to processor 604 in FIG. 6A, as described above. Memory 602a-n may function similarly to memory 602 in FIG. 6A, as described above.

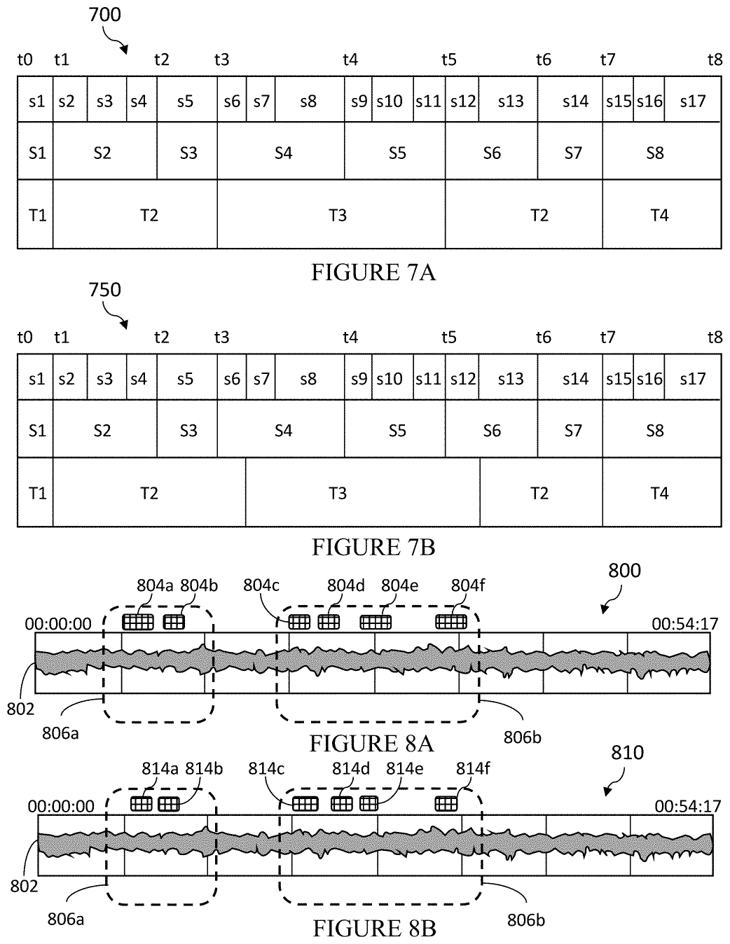

Using an audio data leveraging system as described herein, audio files (e.g., podcasts, social network conversations, etc., as described herein) may be segmented by topics and speakers. Beyond the segments determined by typical speech-to-text algorithms that are determined largely based on pauses in speech, individual sentences may be identified within segments. In an example, each sentence may further be attributed to a speaker. Topics also may be identified and tracked against segments and sentences. FIGS. 7A-7B are diagrams showing exemplary segmentations of an audio file, in accordance with one or more embodiments. In diagram 700, t0-t8 indicate timestamps, for example, pauses in speech or other indications of segment beginnings and endings. In some examples, each of segments S1-S8 may be correlated to two timestamps—one at the beginning of the segment and one at the end of the segment. Segments S1-S8 may be identified using a speech-to-text algorithm or program. An audio data leveraging system, as described herein, may further identify sentences s1-s17 within segments S1-S8 (e.g., segment S1 comprising sentence s1, segment S2 comprising sentences s2-s4, segment S3 comprising sentence s5, segment S4 comprising sentences s6-s8, etc.). An audio data leveraging system, as described herein, may further attribute topics T1-T4 to one or more segments and/or sentences. For example, in diagram 700, topic T2 is discussed in segments S2-S3 and S6-S7 (i.e., including sentences s2-s5 and s12-s14), and topic T3 is discussed in segments S4-S5 (i.e., including sentences s6-s11). In another example, in diagram 750, however, topic T2 is discussed in more than segments S2-S3, including some or all of sentence s6, and less than segments S6-S7, excluding some or all of sentence s12. Also in diagram 750, topic T3 is discussed approximately from sentences s7-s12, which includes part of segment S4, all of segment S5, and part of segment S6. In some examples, snippets of the transcript and/or audio file may be extracted from the segments and/or sentence, or parts thereof, associated with a topic. Such snippets may be stored in association with a topic and/or sentiment (e.g., using an identifier, table lookup, or other data structure) for ease of reporting or otherwise retrieving and serving to a user, as described herein. A set of snippets associated with a topic may be stitched, or otherwise grouped, together to provide a shortened version or summary of the audio file comprising just the portions of interest.

Topics and their boundaries may be identified using a sentiment score (e.g., score associated with a sentiment, as described herein). Words and phrases may be qualified with a sentiment score, which may be used to identify a topic. A plurality of factors may influence a sentiment score, including frequency and concentration of a word or phrase associated with a topic. FIGS. 8A-B are annotated audio file representations showing highlighted portions, in accordance with one or more embodiments. In audio file representation 800, 54 minutes and 17 seconds of audio file 802 is shown, which may include some or all of audio file 802. A first word or phrase of interest (e.g., technology) to a topic (e.g., technology products) is detected in the portions (e.g., sentences or segments) identified in portion identifiers 804a-f. In some examples, portion identifiers 804a-f may identify one or both of a sentence and a segment, or a part thereof. Portion identifiers 804a-f may further indicate frequency and/or concentration by color, pattern, height, size, or other differentiating feature. Snippets 806a-b may be extracted and stored in association with a topic and/or sentiment score indicated by the term or phrase of interest.

In audio file representation 810, another (i.e., second) word or phrase of interest (e.g., product) to the same topic (e.g., technology products) may be detected in portion identifiers 814a-f, also in a significant frequency and/or concentration. In some examples, portion identifiers 814a-f may indicate that this other word or phrase of interest shows up in a similar or different frequency and/or concentration than the word or phrase of interest identified in portion identifiers 804a-f, but the same snippets 806a-b similarly would capture the significant instances of the first and second word or phrase of interest to the topic, thereby strengthening the indication that snippets 806a-b are associated with the topic. As described herein, snippets 806a-b may be extracted and stored in association with the topic and/or a sentiment score. In some examples, snippets 806a-b may be stitched or grouped together to provide a shortened version of the original audio file comprising the portions discussing a topic of interest. In other examples, additional audio clips (e.g., shortened versions of other audio files by the same speaker(s), advertisements, other audio clips related to the content) may be added to the shortened version.

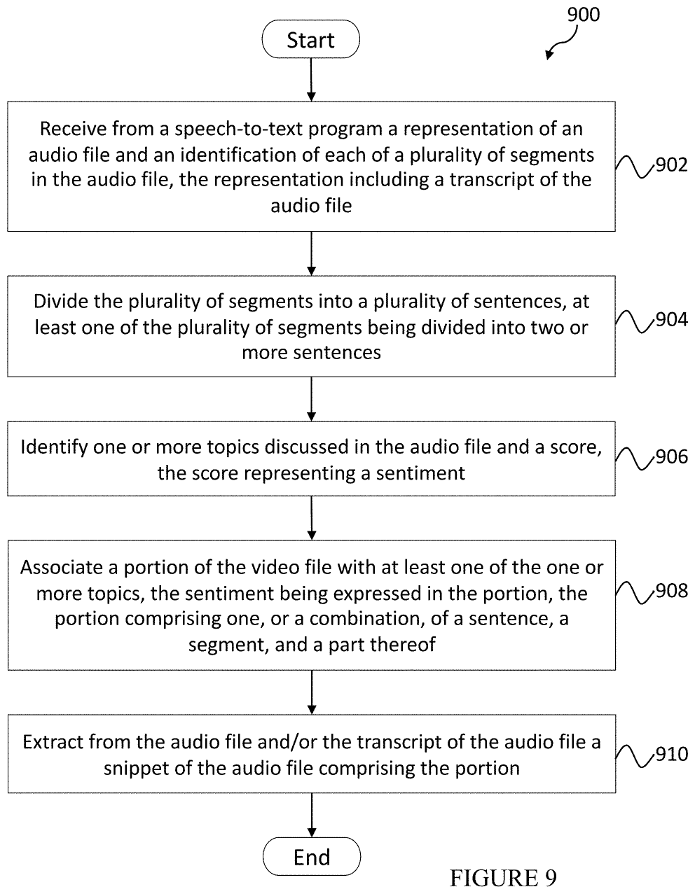

FIG. 9 is a flow diagram illustrating an exemplary method for identifying and extracting a snippet from an audio file using an audio data leveraging system for insights, in accordance with one or more embodiments. Method 900 begins with receiving from a speech-to-text program a representation of an audio file and an identification of each of a plurality of segments in the audio file at step 902. The representation may include a transcript of the audio file, and each identification may include a beginning timestamp and an ending timestamp. The plurality of segments may be divided into a plurality of sentences at step 904, at least one of the plurality of segments being divided into two or more sentences. As shown in FIGS. 7A-7B, a segment may comprise one sentence, while other segments may comprise two or more sentences. One or more topics discussed in the audio file and a score may be identified at step 906, the score representing a sentiment, for example, as expressed in a segment or sentence regarding a topic. A portion of the video file may be associated with at least one of the one or more topics at step 908, the sentiment being expressed in the portion, the portion comprising one, or a combination, of a sentence, a segment, and a part thereof. A snippet of the audio file may be extracted from the audio file and/or the transcript of the audio file at step 910, the snippet comprising the portion of the audio file. In some examples, additional steps additional steps for leveraging audio data for insights, as described herein, may be included in this method to identify and extract a snippet. The snippet may be stored for use in a report to a user or to be retrieved in response to a user request, for example, on a networking, sales, or marketing platform or service. In some examples, the snippet may be stitched or grouped together with other snippets (i.e., portions) associated with the topic (and sentiment, in some cases) to provide a shortened version of the original audio file comprising the portions discussing a topic of interest. In other examples, additional audio clips (e.g., shortened versions of other audio files by the same speaker(s), advertisements, other audio clips related to the content) may be added to the shortened version.

Another exemplary use for snippets generated using the methods described herein is for search engine optimization (SEO). By providing snippets of audio content from the results of a search on a search engine, a search engine can increase dwell time (i.e., an amount of time a user remains on the search results page or other webpage) and reduce bounce rates (i.e., listening to, or otherwise consuming, a snippet provided with search results by a search engine does not result in a bounce). An internal linking structure also may be provided, wherein pages of snippets related to a topic may be linked together in a structure to make the audio content more discoverable to users and search engines.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for leveraging audio data for insights, the method comprising:
receiving a primary source configured to provide access to an audio source;
identifying the audio source from which the audio data may be obtained, the audio source comprising one, or a combination, of a company executive source, a company source, a company specialty source, and a company organization type source;
extracting an audio source identity from audio source metadata associated with the audio source;
extracting a snippet from the audio source, the snippet being identified as expressing one or more sentiments;
generating value-add data associated with the audio source identity;
generating a score associated with the one or more sentiments; and
reporting the audio source identity, the snippet, and the value-add data.

2. The method of claim 1, wherein the primary source comprises a URL.

3. The method of claim 1, wherein the audio source comprises a podcast.

4. The method of claim 1, wherein the audio source comprises an audio network conversation.

5. The method of claim 1, wherein the audio source comprises a video.

6. The method of claim 1, wherein the score comprises a polarity score.

7. The method of claim 1, wherein the score comprises a subjectivity score.

8. The method of claim 1, wherein the score comprises a rank score.

9. The method of claim 8, wherein the rank score is derived from one or more other scores.

10. The method of claim 1, further comprising marking the audio data with a unique transaction identification (ID).

11. The method of claim 1, further comprising selecting the primary source from one or more primary sources.

12. The method of claim 1, further comprising categorizing the audio source into one or more of a company executive source, a company source, a company specialty source, and a company organization type source.

13. The method of claim 1, further comprising transcribing a plurality of segments of the audio source using a speech to text algorithm.

14. The method of claim 1, further comprising matching the audio source with one or more accounts associated with a user using a user profile.

15. The method of claim 1, further comprising matching the audio source with one or more accounts associated with a target.

16. The method of claim 1, wherein extracting the audio source identity comprises recognition of topics and keywords based on analysis of the audio source metadata.

17. The method of claim 1, wherein extracting the audio source identity comprises matching the audio source with a set of given topics based on a user's preference.

18. The method of claim 1, wherein extracting the audio source identity comprises matching the audio source with a set of topics based a categorization of the audio source.

19. The method of claim 1, wherein extracting the audio source identity comprises generating a list of audio source guest names matched to company information.

20. The method of claim 1, wherein extracting the audio source identity comprises extracting a topic and/or a keyword based on the audio source metadata.

21. The method of claim 20, wherein extracting the audio source identity further comprises deriving a theme from the topic and/or the keyword.
